(19) United States
(12) Patent Application Publication
(10) Pub. No.: US 2002/0156712 A1
(43) Pub. Date: Oct. 24, 2002

(54) Parametric representation scheme and systems for description and reconstruction of an intellectual property management and protection system and corresponding protected media

(75) Inventor: Avni Harilal Rambhia, Piscataway, NJ (US)

Correspondence Address: Bo-In Lin, 3475 North First Street, San Jose, CA, 95134-1803, US

(73) Assignee: Soft Park Group, Ltd.

(21) Appl. No.: 10/080,790

(22) Filed: Feb. 20, 2002

Related U.S. Application Data
(60) Provisional application No. 60/270,238, filed on Feb. 20, 2001.

(51) Int. Cl. G06F 17/60

(52) U.S. Cl. 705/36

(57) ABSTRACT

The present invention provides a system comprising a scheme capable of compactly representing or configuring, whole or parts of an Intellectual Property Management and Protection System, which is intended to protect Protected Media. This invention also provides the above system, wherein the scheme in the above system is capable of representing or configuring parts of or a whole Intellectual Property Management and Protection System. This invention further provides the above system, wherein the scheme comprises a method to identify, represent and configure a specific Task.

This Application claims a Priority Filing Date of Feb. 20, 2001 benefited from a previously filed application Ser. No. 60/270,238

### BACKGROUND OF THE INVENTION

1. Field of the Invention

This invention relates generally to the design and configuration of an intellectual property management and protection (IPMP) system. More particularly, this invention relates to a novel technique for applying a parametric representation methodology to describe and implement a broad spectrum of IPMP schemes in terms of their generic components and the interaction between them and the user-specific application, and enables the creation of a generic system for compatible applications between different IPMP System configurations and digital media players.

2. Description of the Prior Art

A person of ordinary skill in the art in the software industries is still faced with many challenging technical difficulties in developing a broad platform that can use multiple intellectual property management and protection (IPMP) systems to effectively manage and protect various intellectual properties from digital piracy. Meanwhile, there is an ever-increased demand for a broad platform to implement multiple IPMP systems such that protection against digital piracy can be effectively and economically carried out. Specifically, the effects and losses from piracy have evolved over the past twenty years from mechanical piracy to today's digital piracy. An action of physical theft involves an ownership transfer of a mechanical object (cash, a car, a TV set . . . ) from the original legitimate owner to a thief and the manufacturer of the TV set is not affected. It is very obvious that the original owner suffers while the thief gains. In contrast, the owner of the intellectual property rights of a digital “object” under the circumstances of digital or analog piracy no longer suffers the loss of the physical possession of such object. And, under certain situations may even be profited from an action of piracy. However, more and more, the owner of the intellectual property now suffers greater losses as the piracy technology progresses. Analog piracy though has some inherent limitations. First of all, there are the quality losses caused by repeated duplications. For example, a fourth generation copy of a magnetic audio-tape or videotape has very poor quality and therefore little value and utility. Additionally, the analog duplication process is typically complex and time consuming. Analog copying equipment has a significant cost and requires the original to be in close geographical proximity to the copy target. Additionally, there is a cost to transportation of the copy. However, digital media piracy has none of these drawbacks. A digital copy can be copied and transferred on the Internet with very high speed, minimal costs, and perfect duplication containing all of the original contents. In addition, digital content can typically be compressed with insignificant loss in quality, further reducing transmission and storage costs, and increasing the ease of its piracy. This digital piracy represents an unprecedentedly large threat to the ability of the owners of digital intellectual property to exercise their rights to their holdings in every manner they choose.

As modern technology provides convenience for unauthorized use of digital Protected Media and that also becomes a major hindrance to the distribution of valuable digital media on the Internet. It represents one of last critical frontiers to be overcome before the digital distribution market for digital media can be realized. Digital Rights Management (DRM) and Intellectual Property Management and Protection System (IPMP) are technologies that have been in development over almost ten years to provide easy authorized use and very strongly hinder unauthorized use of Protected Media. As of now, the demand for an effective intellectual property management and protection system becomes an ever increasingly urgent matter.

IPMP Technologies can be divided into two parts, i.e., management technologies and protection technologies. Protection technologies are typically high-complexity and require significant resources at the Player side. Management technologies are low complexity tasks in the Player, but consume significant technology resources, and are expensive in the Service and other domains. Protection technologies are often open for public scrutiny. Management technologies are highly proprietary, and are almost never public in their entirety.

The foremost requirement for any commercially viable IPMP system is a seamless experience for the user. In application spaces that use a single content format, this has been achieved by creating IPMP Systems in conjunction with the predefined type of Player Application. This is critically important to achieve successful market penetration of the associated service. In DVB (satellite cable TV) for instance, the simulcrypt scheme adapted the patented protection technology of U.S. Pat. No. 05,799,089 as a standard means of protection. The management aspect was left open, with different cable providers capable of sending their own channels of protected information to the user. It was after DVB was broadly adopted that the MPEG-2 and digital cable market in general took off and created revenue. Similarly in the case of the DVD standard, protection mechanisms were made standard. For both these markets, the players were hardware based and therefore easily certifiable.

The problem of Digital Media Players in the current market is, however, a bigger and wider one. Users expect to be able to play different formats of digital multimedia in the same Player application, e.g., VCD and DVD can both be played in Windows Media Player, if provided with the required plug-ins. The users also expect to play content from different providers in the same Player, e.g. a CD from Universal and a CD from BMG in the same CD player. Given the fact that most digital Players need to be treated as potentially hostile, the security demands on any IPMP System are high and change with time. Additionally, there is a need for seamless viewing experience for the user. Given the widely different types and value of content being processed, the option of an industry-wide agreement on a given IPMIP System is unfeasible. Finally, as U.S. Pat. No. 05,715,403 correctly points out, there are now multiple beneficiaries of the value of a certain piece of digital content. These beneficiaries have different business models, different security level requirements, and therefore are almost certain to need different IPMP System providers to meet their needs. Similar considerations are bound to apply to software sharing and other applications of shared digital media.

Thus the existing paradigm of one IPMP System per Player Application does not fulfill the needs of the newly emerging digital media distribution market. Requirements on any realistic solution dictate that more than one IPMP System should be able to work on a given Player Application. Hosting several IPMP Systems at a Client is a possible solution. However, such a solution is neither practical nor optimal, since supporting several different and separate IPMP systems is not cost effective. Several difficulties arise from such systems. For examples, the object code occupies large volumes in memory storage or size of chip level components are large in area, and is difficult for one manufacturer to implement given the large number of potential proprietary solutions available in the marketplace.

Furthermore, to enable a truly free and fair marketplace, and to keep the costs of Player Applications and legitimate content consumption low, it is essential to expect to support a given IPMP System on a variety of different Player Applications. Such an IPMP system should also be implementable without a series of combinatorial and exhaustive licensing relationships between all IPMP Systems and Player Applications.

Some patents exist that propose fundamental original technology for parts of an IPMP System. A good example for encryption technology is U.S. Pat. No. 4,405,829 that describes the RSA algorithm for asymmetric encryption that is at the heart of most public-key cryptography systems. U.S. Pat. No. 05,715,403 describes, among other things, a grammar to describe the usage rights associated with the protected media to arbitrary levels of detail and the processes to author, transport and utilize such a description. U.S. Pat. No. 06,138,119 defines, among other things, methods to define rights management data. Both these systems address another component of IPMP Systems—usage rights. U.S. Pat. No. 06,233,684 describes, among other things, a watermark creation scheme and a client-side means for respecting the restrictions laid down by the watermark. Several patents exist that are based on or more such fundamental technologies, adapting their use by means of “wrapper technology” to a specific application space. For example, U.S. Pat. No. 04,969,190 creates additional processing above RSA encryption to achieve additional encryption. U.S. Pat. No. 05,799,089 describes a method for block-encryption on top of a standard encryption scheme that allows for efficient encryption of streams. U.S. Pat. No. 06,016,348 describes, among other things, a means to use one of several possible encryption algorithms while encrypting video data, with such identification being embedded in the encrypted content itself. Several patents also exist that describe an entire IPMP System, typically with an emphasis on the server technologies, for a specific application space. For example, U.S. Pat. No. 06,209,097 describes a scheme for managing and protecting image data, adding novel techniques on top of pre-existing encryption and authentication technology.

While each of these patents valuably addresses a specific technology requirement for a specific application, none of them provides a universal solution to all data protection and management needs. The need for a variety of solutions is emphasized by the fact that multiple patents have been granted for different solutions in the same application space. Multiple but finite fundamental technologies exist, and there is a demonstrated trend for solutions to assemble these technologies in different configurations. There is no existing art that exploits this trend to enable multiple IPMP Systems to co-exist while sharing these fundamental resources. Therefore, a need still exists in the art to provide an improved configuration and procedure of implementation to effectively resolve the aforementioned difficulties.

### SUMMARY OF THE PRESENT INVENTION

It is therefore an object of the present invention to provide new and improved systems and methods to implement an IPMP system to perform part or whole of the process of protecting and managing Protected Content without the limitations and difficulties as that encountered by the prior art techniques.

Specifically, it is an object of the present invention to provide systems and methods to enable an IPMP system with a new and flexible configuration that performs part or whole of the process of protecting and managing Protected Content. The IPMP system is described and implemented with an aggregation of Tools The IPMP System is described and implemented in terms of one Tool or an Aggregation of more than one Tools. Each Tool performs one or more Tasks wherein a Task or an IPMP task is employed to perform function or sub-process within the IPMP system and the embodiment of one or more Tasks is an IPMP Tool or Tool. Such constituents of an aggregation are also referred to as Components. This invention provides a means for Components to be one of several pre-existing Tools, or an arbitrary Tool corresponding to a description of an IPMP Task.” As each IPMP task has functional features, all of these IPMP tasks of this invention have common characteristics that 1) these tasks are implemented with popular public algorithms. 2) A wide variety of equivalent implementations of the same functionality would be available among all these tasks. 3) These tasks include computationally intensive algorithms that lead to platform-specific optimized implementations thus are compatible with schemes developed by a wide variety of vendors. 4) A set of parameters and values can be identified and standardized to support a specifically designated class of Tasks.

Additionally, this invention provides methods to author Protected Content to carry such descriptions of the IPMP System(s) that protect it and methods for the client application to utilize these descriptions and its own resources to reconstruct such IPMP System(s).

The problems of complexity and size of resources needed to run multiple proprietary IPMP Systems on a Client system is resolved in this invention by enabling resource consolidation. For the purpose of achieving this goal, a configurable, grammar-based representation referred to as Parametric Representation, to identify such well-known and widely used Tasks is defined. This parametric representation further provides a means to define an IPMP System in terms of an arbitrary assembly of more than one IPMP Tool. The process thus allows the authoring of a compact definition of the IPMP System, which may be carried within or referenced by the Protected Media. A scheme is further defined that allows the selection of appropriate implementations of the Tasks by the Player Application (called Parametric Tools). This invention further provides a method to construct the required IPMP System(s) on the fly at the client side using the selected Parametric Tools, and/or proprietary IPMP Tools. Furthermore, this invention provides a means to author protected media in a Task-aware but Tool-agnostic manner.

Therefore, this invention discloses schemes that allow more than one IPMP System to reside in a given Player Application with minimal replication of resources. The configurations as disclosed in this invention further facilitate the ability of a given IPMP System to reside on multiple Player Applications.

The Parametric Representation disclosed in this invention is specified in terms of a grammar. In any embodiment, this grammar is expressed in terms of a Structured Language, and this Language is further used to express an instance of a parametric representation. Finally, the grammar for parametric representation, in an embodiment, allows inclusion of machine-level language or executable code that could be directly installed and/or executed by the Client.

While standard schemes for some specific Tasks may be disclosed previously or patented, as discussed in the previous section, this invention discloses the novel general syntactic schemes with an aim to represent a description of parts or the whole of an IPMP System. The general syntactic schemes of this invention are not addressed by any of the prior art references discussed above. The scheme disclosed in this invention enables and allows for economical clients (minimally replicated resources), flexible use of Protected Media and high security, since sensitive data need never leave the Client's high-security areas for processing inside the IPMP System. It enables a free and fair market for Client and IPMP Systems alike since potentially any Client could enable any IPMP System at minimal additional cost, if such support is desirable by both. At the same time, the representation scheme will be light in terms of storage size, so that storage and transportation of the representation can be carried out economically.

These and other objects and, advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIG. 1 depicts an end to end overview of the Intellectual Property Management and Protection Process, divided into Publishing, Serving and Playback zones.

FIG. 2 shows the interactions between Client, Application and IPMP System to honor a Client Request.

FIG. 3 depicts the notion of IPMP Task Wrapper on top of an IPMP Task Implementation wherein the Task Implementation is for a well-known and widely accepted algorithm, while the Wrapper is proprietary.

FIG. 4 provides an example of the internal working of a complete IPMP System by clearly identifying Tasks that are computationally intensive but common to many different types of IPMP systems.

FIG. 5 is a block diagram for providing an overview of the structure of the IPMP_Task_List grammar.

FIG. 6 is a block diagram for providing an overview of the structure of the IPMP_Tool_Aggregation grammar.

FIG. 7 shows the grammar definition for IPMP_Task_List.

FIG. 8 shows the grammar definition for IPMP_Tool_Aggregation.

FIG. 9 is a flowchart depicting the process of selection of a Tool to fulfill the requirements set forth in an IPMP_Task instance.

FIG. 10 shows a preferred embodiment illustrating the use of the parametric description framework to describe the required IPMP Task, to describe an IPMP Tool that embodies a given Task, and to depict the process of selection of a Tool to fulfill the requirements set forth in an IPMP_Task instance matching the IPMP Task required to an available IPMP Tool.

FIG. 11 shows a preferred embodiment illustrating the interpretation of Parametric Aggregation by the Player Application.

FIG. 12 shows a preferred embodiment illustrating the use of Parametric Aggregation to construct a complete IPMP System from IPMP Tools. Such Tools may or may not have been chosen using the Parametric Description selection process.

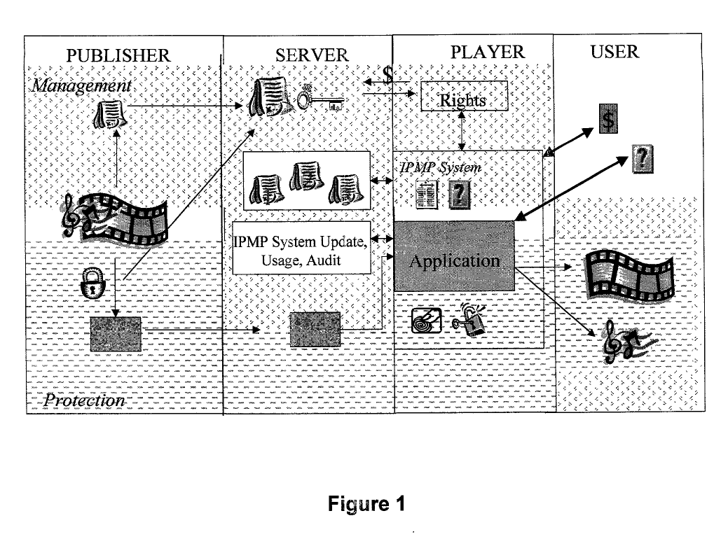

### DETAILED DESCRIPTION OF THE PREFERRED EMBODIMENT

The intellectual property management and protection systems are commonly referred to as the IPMP systems. The target of protection by IPMP system includes the rights based on the ownership of the intellectual property prescribed by different intellectual property laws. The ownership of an intellectual property may include the rights of use, sales, publication, and derivative works of the digital media and can also include the quality of service (QoS) infrastructure used to deliver the content or the algorithms used to compress the content. The intellectual property (IP) can belong to the content owners, the delivery layer, the portals, the re-sellers, or anyone else in the value chain. Indeed, IPMP implementations at the Terminal may be treated as the Terminal provider's IP.

The Management process ensures that owners of the IP rights receive due compensation for its use. A well-designed management process is nearly invisible and reliable. Protection enforces the rules of compensation, and is not released until adequate compensation has been received by all concerned. It is critical to protect the content because that is a most important requirement to adequately manage the intellectual properties in the real world. Digital rights management (DRM) is similar to IPMP in intent. It usually refers to the policy governing the use of content as established by a single owner of the content for a given user, and the purchase, transfer and maintenance of such rights. In this sense, it is more limited in scope and application space than IPMP. When designed and implemented well, and used wisely, IPMP greatly facilitates and encourages legitimate use of content, and heavily discourages its piracy.

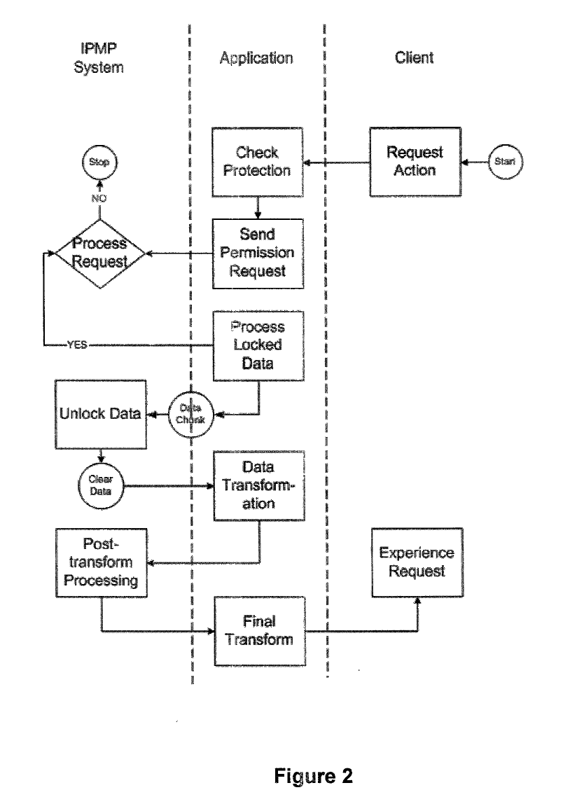

With reference to FIG. 2, the IPMP Process works in four different spaces: the Publisher space, the Server space, the Player Application space and the User space. Two processes occur on (Protected) Media over these spaces: Management and Protection. The flecked area represents processes dealing with Management of the Media. The dashed areas represent processes dealing with Protection of the Media. Phase one of the process is Publishing, done in the Publisher space. The specifics of the IPMP System to be used are defined at the Publisher. These may include, but are not limited to, definition of usage policy associated with the protected media, and the type of encryption to be used. Parameters of usage policy include method of definition, and a policy definition consistent with that method of definition. Parameters of encryption include the encryption algorithm, percentage of data to be encrypted, specifications on which blocks of the Media are to be encrypted, markers for the same, and any other ancillary information. Subsequent processing involves including the decryption key, a link to the decryption key, or some other type of information that would enable retrieval of the decryption key in the Media. Retrieval of the key may only be possible through a specific IPMP Task implementation type—its identification and the data that the Client requires for configuration form the parameters for this Task.

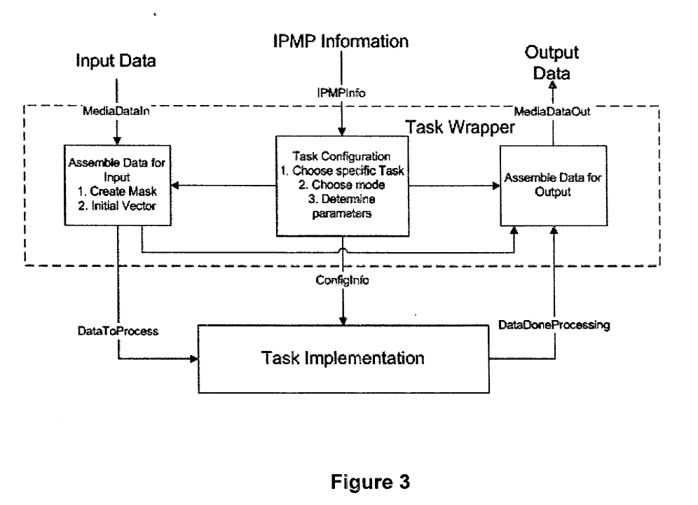

All required information is assumed to be available to the Player Application, through the Server space components. Using appropriate IPMP Information, the Player Application is able to instantiate and initialize all tools required for processing the Protected Media, such as the decryption engine, fingerprinting engine, Rights Management module and auditing system. The end user can then experience the Media after paying any requisite compensation and otherwise fulfilling all pre-conditions. Should the user request additional privileges to the Protected Media, the IPMP System is capable of processing such a request, as indicated in FIG. 3. The functions that an IPMP System performs in the Player application space are typically Key extraction, Decryption, Fingerprinting and Rights Management, Watermark detection, Fingerprint insertion, Audit Trail Generation and Maintenance of User's Rights.

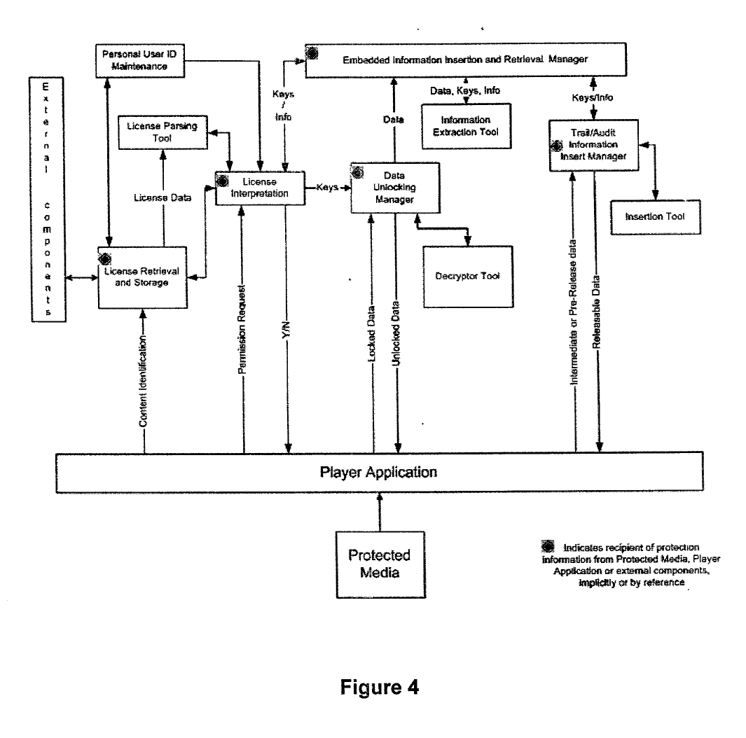

These functions can be divided into two classes. One class consists of entirely black-box functions that are often certified for security and carry technology and/or implementation trade secrets and these Tasks are refereed to as class of Closed Tasks. The other class consists of implementations of algorithms that are well defined within a given application space and are often openly available for review and implementation, within some security and certification restrictions where applicable. These Tasks are referred to as class of Open Tasks. Typically the latter classes of Tasks are implemented as an integral part of the Player Application, and are heavily optimized for execution of the platform that supports the Player Application. While Closed Tasks are typically embodied by a finite set of unique Tools, Open Tasks can be expressed as a set of well ordered information. Tools that implement Closed Tasks will typically form a “wrapper” around the Open Task implementations as that indicated in FIG. 4.

The wrapper performs the function of interpreting incoming IPMP Information and configuring the (Open) Task as required by the Protected Media. Incoming Media Data from the Protected Media is processed and placed in the appropriate order and form for processing by the Task. If the Media Data does not need to be processed, it is directly sent to the Output section of the wrapper. This frequently happens, for example, when only a certain percentage of data (rather than all of it) is encrypted, often for reasons of real-time or error-resilience constraints. The Task executes its operations on the data supplied to it by the wrapper, based on the configuration by the wrapper, and returns the processed data to the wrapper. The wrapper then assembles all data for output and returns it to the Player Application.

A system that performs part or whole of the process of protecting and managing Protected Content is an IPMP System. Any function or sub-process performed within this System is referred to as an IPMP Task or Task. The embodiment of one or more Tasks is an IPMP Tool or Tool. Thus, an IPMP System is viewed as a Tool or an aggregation of Tools that perform one or more Tasks. The current invention provides a means of allowing Media protected by different IPMP Systems to share an Open Task implementation that is available to a given Player Application. It also allows one of several equivalent Closed Tools to be equivalently used to process a given piece of Protected Content. This is important to enable free-market conditions as well as facilitate the creation of economical Player Applications even in the case where a Task cannot be openly specified. It further supports the combination of one or more Open Task and Closed Task implementations into any arbitrary configuration to re-create the IPMP System on the fly on the Player side. Within a reasonably well-defined Application space, this allows the existence of multiple IPMP Systems in a given Player Application with minimal replicated resources.

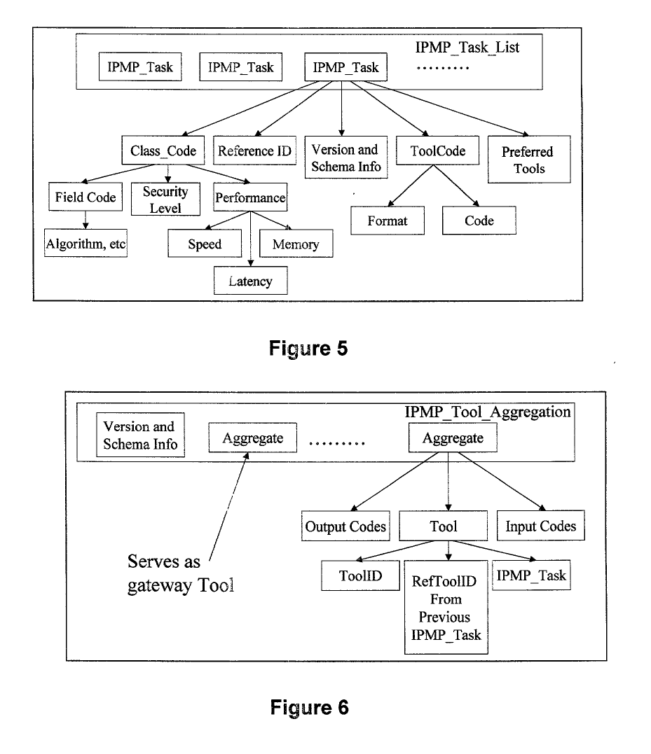

FIG. 5 shows the internal structure of a typical IPMP System. There are three major areas of operation that are evident—

1. License retrieval, processing and management

2. Data unlocking

3. Meta data insertion, retrieval and interpretation and Often working in the background is a fourth area of operation—that of security maintenance. Different modules within the Player and the IPMP System need to be continuously monitored for integrity and secure channels need to be established to transmit sensitive information in a secure manner. Good examples of such sensitive information are the keys being sent from the License Manager to the Data Unlocking Manager.

The boxes that carry a “Manager” in their description are typically embodied and implemented as Closed Tools and those carry a “Tool” in their description are typically embodied by Open Tools. An aggregation of such Open and Closed Tools forms a complete functionality within an IPMP System. These functional blocks interact internally within themselves, and externally with other functional blocks, via a well-defined set of interfaces.

For example, the Data Unlocking Manager (a Closed Tool) wraps the Decryptor Tool (an Open Tool) to enable a data unlocking functionality. The Data Unlocking Manager has a bi-directional connection with the Decryptor Tool as that shown in FIG. 5 for providing a closer look at this interface. The data unlocking functionality as a whole has art interface with the License Interpretation module for key exchange, has an interface with the “Embedded Information Insertion and Retrieval Manager” for data supply, and a bi-directional interface with the Player Application for Media Data exchange.

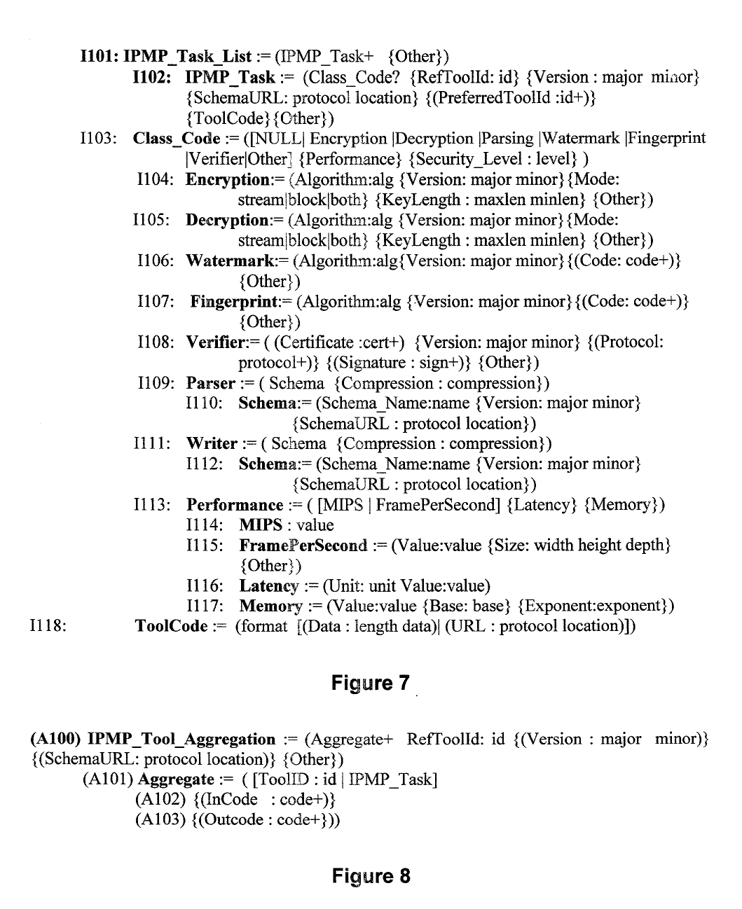

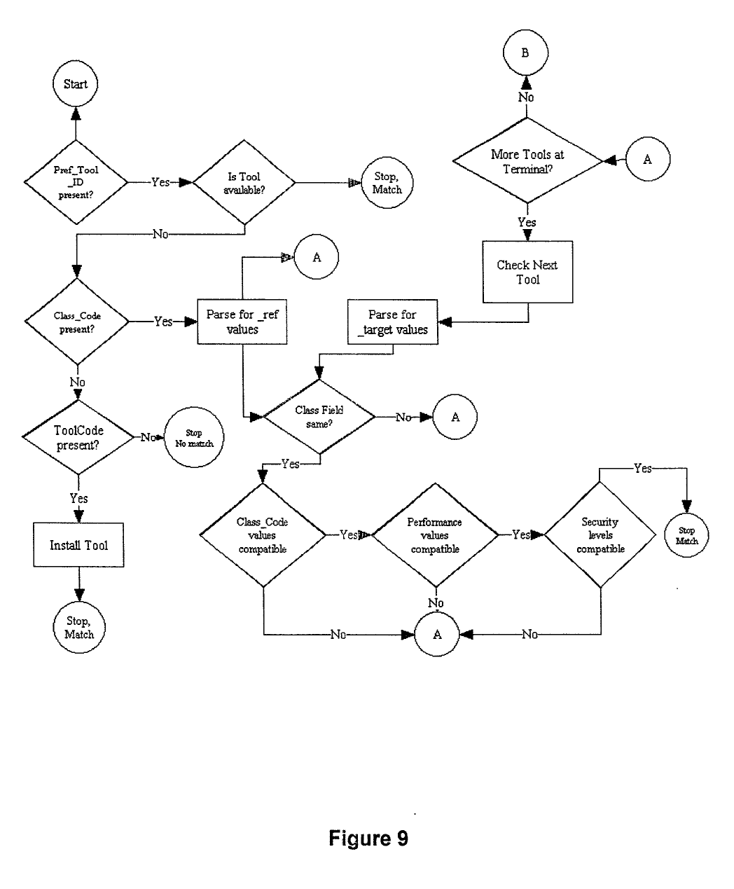

With reference to FIG. 6, an IPMP_Task-List (I101) is a list of one or more Parametric Descriptions of IPMP Tasks (I102). This list is attached (directly or by reference) to the Protected Media at the time of Publishing, and is parsed and interpreted by the Player application. The Parametric Description has up to three components: The Task Description (Class_Code, ref), a list of known Tools that embody the Task (PreferredToolId, ref), and a direct or indirect link to executable code for a Tool that embody the Task (ToolCode, ref). With reference to FIG. 7, an IPMP_Tool_Aggregation specifies one or more Tools that are members of the Aggregation and the manner in which they connect to each other. Each of these specifications will be described in greater detail with respect to the specific grammar elements. Units of the parametric aggregation may be defined in one of the three following ways: Closed Tools identified by their Tool IDs, Open Tools defined in terms of their Task Descriptions (this Task Description having the same syntax as one instance of an IPMP_Task), or in terms of a reference to an IPMP_Task having been previously defined within an associated IPMP_Task_List. The benefits of using the IPMP_Task_List to list all open task definitions and then referencing these in the Aggregation are as follows:

1). If the same Task is being reused in multiple Aggregations, then this leads to a more compact representation. It also allows for easy editing since the Task Description need be altered only once and will affect all Aggregations as intended.

2). In the preferred embodiment, the Player Application first searches for and matches all Task descriptions in the IPMP_Task_List. It then begins the process of instantiating Aggregation Tools. If a reference to a Task in the Task List is used, then the matching need be performed only once and the known Tool reference is used for meeting the Aggregation needs. If a Task Description is placed in the Aggregation, then Tool matching must be done for each occurrence of this Task Description, leading to lower performance and higher resource consumption.

However, it is not necessary that a Task defined in the Task List must be part of an Aggregation to be used to protect the Potable Protected Media. Depending on the format of such media and the associated application, the manner in which a Tool fulfilling an IPMP_Task description in the IPMP_Task_List may be implicitly known or explicitly specified in an independent manner. Only if the Tool must be used in conjunction with other Tools in a pre-defined manner, with such a group being invoked under a unified name, is the definition of an Aggregation necessary and recommended.

Parametric Representations are based on the grammar described below. A grammar is a convenient means of defining a valid sequence of symbols for a language. This invention must be embodied in two stages. First, the grammar must be mapped to a Structured Language. Second, the Structured Language must be used to express an instance of a Parametric Representation.

A Structured Language must fulfill the following conditions to be able to support the current :invention:

1. It must support syntax to represent, directly and/or implicitly, Tasks in the field of application.

2. It must support syntax to represent, directly and/or implicitly, identification of a specific implementation and/or type of a given Task.

3. It must support syntax to represent, directly and/or implicitly, configuration parameters for the Tasks in the field of application.

4. It must support syntax to represent, directly and/or implicitly, values for the configuration parameters identified above.

5. The Structured Language may be based on symbols with English meaning, symbols with a defined linguistic meaning, binary information with a meaning based on pattern and context, punctuation with a meaning based on pattern and context, or a combination of any of the above.

A Structured Language would be a more powerful framework to realize this invention if it additionally supported one or more of the following additional features:

1. Extensible syntax

2. Extensible semantics

3. Alternative text and binary representations

4. Variable length fields

5. Exploitation of any known structure in the information to be represented.

6. Wide-spread acceptance and/or standard status

XML is an emerging international standard defining flexible textual representations for structured data. This is one example of a Structured Language, which may provide the framework to enable the proposed scheme, and a currently preferred embodiment. Additionally, since some Structured Languages (like XML) are text based, they are non-optimal in terms of size of the data. The most preferred embodiment will provide for compression of the text representation based on maximal use of context information. For example, if a given tag may carry only one of two values, then one bit of digital information is sufficient to represent this value. In contrast, the grammar may specify a multiple-letter value for semantic clarity, which would take a multiple number of bytes if represented naively. The clear structure of the grammar specified by this invention provides an obvious mapping of the Parametric Representation to its most concise form for any Structured Language chosen as a means of embodiment.

In defining the grammar of the Parametric Representation, the following symbols have been used. Note that this representation of the grammar itself constitutes a Structured Language and can, as such, be used to directly express an instance of a Parametric Representation. As one of the preferred embodiments, it represents some of the desirable characteristics of this invention even though it is not an optimal implementation. Also, this exemplary representation does offer conciseness and obvious correlation with the grammar and will therefore be used as an embodiment for the purposes of examples in this disclosure.

An Element is a syntactically complete part of a sentence. One or more Elements of the same type may appear in succession, this is termed as a List. A List with zero or more Elements is indicated by a “*” after the Element name. A List with one or more Elements is indicated by a + after the Element name. A List with exactly one or zero Elements is indicated by a “?” symbol after the Element name. An Element may be composed of one or more Elements. A Leaf is an Element that contains no further Elements. All other elements are called Composites. In the grammar, Leaves are represented by a capitalized keyword, followed by a colon, with one or more values that have all letters in lower case. Words in lower case do not physically appear in a sentence, but are manifested by appropriate values. Composites are represented by a capitalized name, followed by the “:=” or “:” signs and the Composite(s) and/or Leaf/Leaves that constitute the Composite.

An open and closed bracket () may encapsulate a Composite, and these brackets shall appear in the sentence. All Composite and Keyword names shall appear in the sentence. Components of a Composite are indicated to the right of a “:=” or “:” sign. A “:=” symbol indicates that some of the components are additionally Composites. The “:” sign indicates that all components are Leaves.

The notation [a | b | c] implies a choice amongst alternatives a, b and c. Exactly one of these alternatives shall appear in a sentence. The notation {} indicates an optional Element. Default values for such Elements may be specified in an embodiment. Brackets, bars or braces do not appear in the sentence.

White spaces (space, tab, new-line) shall be used as delimited between words in the sentence. All white spaces are equivalent. They must be implicitly or explicitly present in the sentence where required by the grammar, and shall not be present elsewhere. Keywords or Element Names will not contain white spaces within them in the grammar definition.

Parametric Description

FIG. 8 depicts the complete grammar for the Parametric Description of an IPMP_Task (I102) and its encapsulation into a List (I101) for inclusion in the Protected Media.

IPMP_Task_List (I101) is a List of one or more IPMP Task Descriptions, along with other optional information. Each instance of IPMP_Task (I102) enables the selection of one required IPMP Tool. It forms the basic building block of the IPMP_Task_List List. It is also associated with Tools to enable the Player Application to perform description matching and to select an appropriate Tool in response to an IPMP_Task in an IPMP_Task_List. Each IPMP_Task instance may contain zero or one instances of Class_Code (I103) which contains the details of the IPMP Task that the required Tool must embody. IPMP_Task may further contain a PreferredToolId element, which lists one or more known Tools that embody the required Task. UUIDs or GUIDs (Universally/Globally Unique IDs) are 16-byte random numbers that can be generated by publicly available programs, and are guaranteed to be unique with a very high probability. They are used by several technology infrastructures to serve as “names” for utility components. A UUID is the currently preferred embodiment for defining a PreferredToolId, and for identifying Tool implementations in general. If no Class_Code is specified, then PreferredToolId must appear in the sentence. If Class_Code is specified, then PreferredToolId may appear in the sentence. Note that this is a procedural restriction, and therefore does not appear in the grammar. A sentence that contains neither a Class_Code nor a PreferredToolId may be ignored. IPMP_Task may additionally contain upto one ToolCode (I118) Element, which directly or by reference contains executable code for one Tool that implements the required Tasks. This can be used by the Player Application to acquire a Tool it may not have, and thus increase the likelihood that it can play the Protected Media. IPMP_Task may contain a reftoolId (I102). This Id is a means of referring to the Tool that performs the IPMP_Task without knowing the exact ID of the specific Tool, which will be chosen. It will be discussed extensively in ensuing process discussions. The Version element in IPMP_Task specifies the version of the Structured Language Mapping that is being used to specify the Elements, this is important for the Language to develop with time. IF the currently preferred embodiment, the default for this is major=1 and minor=0, making the Version 1.0. The SchemaURL element is optional and provides a remote source for accessing the grammar and/or Structured Language Mapping used in the instance of IPMP_Task. The protocol value indicates the method of access. Examples are http, https or ftp. The location value is the actual location of the remote source, for example www.e-vue.com/taskschema/0100/.

An IPMP_Task Element without a Class_Code Element indicates that any one of the specified Tools may be used equivalently to process the Protected Media. This enables the use of the current invention in scenarios where the IPMP Task cannot be defined in terms of an open specification. This usually occurs for security reasons, IP reasons or both. An example is the DVB scenario where there are a finite number of certified IPMP Stream providers, and no other information regarding the type of the Task is available. We now discuss the Class_Code (I103) syntax.

The first Element within the Class_Code instance indicates the broad class of the Task, and will be referred to as the Class Field. Possible classes are Encryption, Decryption, Parsing, Watermark, Fingerprint, Verifier or Other. Depending on this class, additional information qualifying the Task follows. Class_Code contains optional Performance information (I113), this will be discussed later. It further contains an optional level of security required for the Tool that will be chosen. If not specified, the lowest security level is acceptable.

For Encryption (I104) and Decryption (I105) Elements, the name of the cipher algorithm must be specified. Encryption Tools perform encryption or ciphering of data, Decryption Tools decrypt or decipher encrypted data. The Version Element is optional, and defaults to major=1, minor=0 in the currently preferred embodiment. Mode is optional, and indicates whether the ciphering/deciphering will be done in stream cipher mode, block cipher mode or both. The default value for the currently preferred embodiment is block cipher mode. The KeyLength element is optional and indicates the maximum and minimum key length (maxlen, minlen respectively) that the ciphering/deciphering algorithm will be required to use. For fixed key length applications, maxlen and minlen will bear equal values. In the currently preferred embodiment, the default values for both maxlen and minlen are 64. Other represents optional additional information.

Fingerprint refers to the process of embedding data into Protected or unprotected Media. Watermark refers to the process of extracting such information embedded within such Media. For the Watermark (I106) and Fingerprint Elements, the algorithm that shall be used to insert/extract data must be specified. The Version Element is optional, and defaults to major=1, minor=0 in the currently preferred embodiment. Code is an optional list of one or more codes that will be inserted into or sought to be recovered from the Media. Other represents optional additional information.

A Verifier Tool is used to verify the identity of a given Tool, to ensure the integrity of certain information or Tools, or to create or insert the information that enables the above verification processes. The Verifier Element (I108) includes one or more Certificate Elements. The Certificate Composite consists of cert, which represents a format of certification that must be supported by the Tool. An example of a cert value is X.509. The Certificate Element may additionally include Version information for the format specified by cert. Version defaults to major =1, minor =0, in the currently preferred embodiment. The Verifier Element further includes an optional list of one or more protocols that the Tool must support in order to carry out the Verification process. An example of this is SSL. The Verifier element further includes an optional list of one or more signature generation or verification algorithms that must be supported. An example of a sign value is SHA. Other represents optional additional information. No defaults are specified for Protocol or Signature elements. If they are not specified, it implies that supports for a protocol and signature respectively are not required.

Parser and Writer Tools respectively interpret or create a document under a specific linguistic scheme. The Parser Element (I109) and the Writer Element (I111) both contain a Schema element (I110, I112) that specifies this linguistic scheme. This scheme typically will, but need not, be based on a Structured Language as discussed earlier. The Parser and Writer Elements further contain an optional Compression scheme specification. This specifies the mechanism used in the Writer case to compress the document created via the schema. In the Parser case, this specifies the mechanism to decompress data to recover a document that can be parsed via the schema. If the Compression Element is absent it implies that no compression/decompression capabilities are required. The Schema Element (I110, I112) contains at least the name of the linguistic scheme required to be used by the Tool. The Version Element is optional, and defaults to major=1, minor=0 in the currently preferred embodiment. The SchemaURL element is optional and provides a remote source for accessing the linguistic scheme specified by Schema_Name. The protocol value indicates the method of access. Examples are http, https or ftp. The location value is the actual location of the remote source, for example www.xrml.org/0100/

The Performance Element (I113) is optional in an instance of IPMP_Task. If the IPMP_Task instance is in an IPMP_Task List, this indicates the minimum performance requirements on the Tool that will be chosen to fulfill the specific Class_Code. If the IPMP_Task instance is associated with a given IPMP Tool, this indicates the performance of the Tool while executing the function specified by Class_Code. Performance speed may be specified in terms of MIPS (millions of instructions per second) or in terms of the number of frames that can be processed per second (FramePerSecond). The MIPS value (I114) is a non-zero positive integer. FramePerSecond (I115) is specified in terms of the number of frames processed per second, this is a non-zero positive integer. FramePerSecond may optionally include the size of the frame in terms of pixel width, pixel height and color depth. These values default to 176, 144 and 24 respectively in the currently preferred embodiment. Latency (I116) is an optional Element that specifies the start-up delay of the Tool in terms of a Unit specification and a corresponding Value. Examples are unit=frames, value=4 or unit=milliseconds, value=42. Memory (I117) is the memory requirement on the Tool in bytes. This is expressed in terms of a value, an optional Base and an optional Exponent. The default value of the Exponent in the currently preferred embodiment is 10, the value of the Base is 2. Thus, a memory requirement of 2048 Bytes (typically referred to as 2 KB) would be indicated as Memory(Value:2), or equivalently as Memory(Value:2 Base: 2, Exponent:10). Note, also, that this can be represented as (Value:1 Base: 2, Exponent:11).

The ToolCode Element (1118) is optional in an instance of IPMP_Task. This acts as a container for, or reference to, a known Tool that embodies the specific Task. An instance of ToolCode must contain a format for the Tool implementation. If the Tool is being directly included, the Data Element indicates the length of the data for the same, followed by the data itself. If the Tool is being included by reference, then the URL Element indicates the protocol by which the Tool can be accessed, and the location for the same.

Parametric Aggregation

FIG. 8 depicts the grammar for IPMP_Tool_Aggregation. An IPMP_Tool Aggregation defines an aggregation of IPMP Tools to function as a larger IPMP Tool or an entire IPMP System. It contains one or more Aggregate (A101) Elements. reftoolId provides a means of referring to the entire Aggregation in Protected Media. In the currently preferred embodiment, this ID is a 16-byte UUID. The optional Version Element specifies the version of the Structured Language Mapping that is being used to specify the Elements, this is important for the Language to develop with time. In the currently preferred embodiment, the default for this is major=1 and minor=0, making the Version 1.0. The SchemaURL element is optional and provides a remote source for accessing the grammar and/or Structured Language Mapping used in the instance of IPMP_Tool_Aggregation. The protocol value indicates the method of access. Examples are http, https or ftp. The location value is the actual location of the remote source, for example www.e-vue.com/aggregate schema/0100/. Other represents optional other information.

Each Aggregate Element (A101) describes one IPMP Tool that is a constituent of the Aggregation, as well as the manner in which it interacts with other Tools in the Aggregation. The first Tool specified serves as the gateway tool to the Aggregation. The Tool may be specified directly via its unique identifier ToolID. In the currently preferred embodiment, this ID is a 16-byte UUID. The Tool may alternatively be specified in terms of an IPMP_Task Element. IPMP_Task has already been discussed in detail. Note that this ID may also take a value that is the RefToolId for a task in an IPMP_Task_List. However, for this to be procedurally acceptable, the said IPMP_Task_List instance must always be bound to any Protected Media that uses this IPMP Tool_Aggregation instance. Additionally, one or more input and/or output contact points for the Tool in the Aggregate may be specified. These are in terms of a List of Input point codes and Output point codes, called InCode and OutCode respectively. InCode is an optional list of one or more codes specifying the input contact points. OutCode is an optional list of one or more codes specifying the output contact points. The absence of InCode indicates that the corresponding Tool has no Input contact points. The absence of OutCode indicates that the corresponding Tool has no Output contact points. An Aggregate Element instance with neither InCode nor OutCode Elements is semantically meaningless and may be ignored. Note that this is not apparent from the definition of the grammar.

When the output code of one Aggregate Element matches the input code of a second, the given output contact point of the first plugs into the corresponding input contact point of the second and a sequential link is established. There should be no duplication of codes to avoid ambiguity. It is possible to have unmatched InCode or OutCode code values, these correspond to pre-defined connection points in the Player Application.

The first Tool listed in the aggregation serves as the gateway to the IPMP System so formed.

### Process of Authoring Content Using Current Invention

The Protected Media that uses the current invention in part or in whole to indicate its Protection Information is now referred to as a Portable Protected Media. Before a Portable Protected Media can be authored, an appropriate IPMP_Task_List and IPMP_Tool_Aggregation Elements are generated. These are attached directly or by reference to the Protected Media. Each IPMP_Task described is given a ReftoolId, the IPMP_Tool_Aggregation has a RefToolId by definition. These ID values must be different from any of the PreferredToolID or ToolID values that may occur in the instances of these Elements. In the currently preferred embodiment, it in fact, the RefToolID occurs from a range of values that is forbidden for assignment to any Tool. All IPMP Information in the Portable Protected Media is then authored in terms of the RefToolID values indicated in the Elements.

### Process of Playing Back Content Using Current Invention

The Player Application retrieves the IPMP_Task_List(s) and/or IPMP_Tool_Aggregation Element(s) associated with the Portable Protected Media.

First, all specified IPMP_Tasks must be matched to appropriate Tools available to the Player Application.

There are three ways of finding a Tool that matches a given IPMP_Task. One is to find if one of the listed PreferredToolIDs is available to the Player Application. The other is to find if any of the Tools available to the Player Application matches the Task Description provided by Class_Code. The third is to use the ToolCode element to make a suitable Tool available to the Terminal. These alternatives can be exercised in any order in a given embodiment. In the currently preferred embodiment, these are performed in the order of enumeration above. In any case, the specific matching process remains the same.

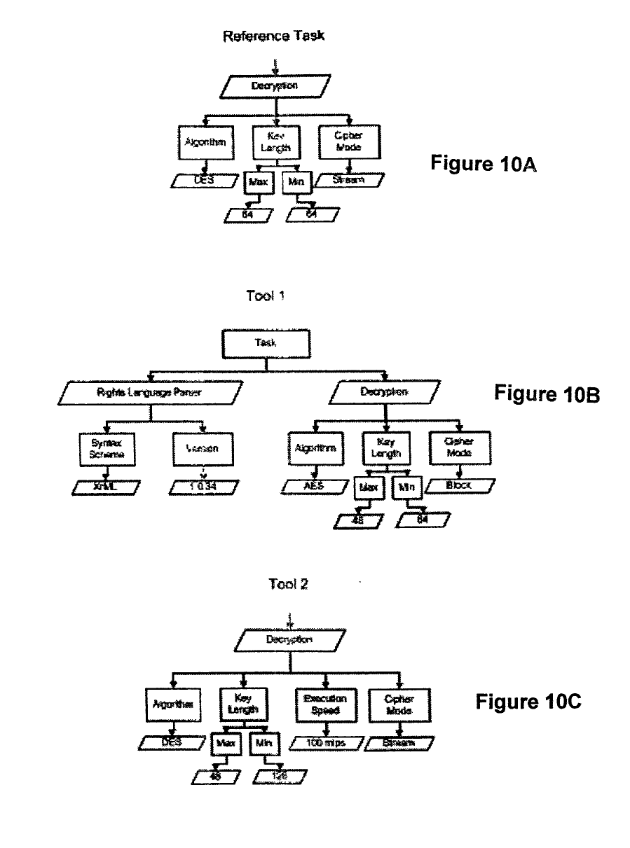

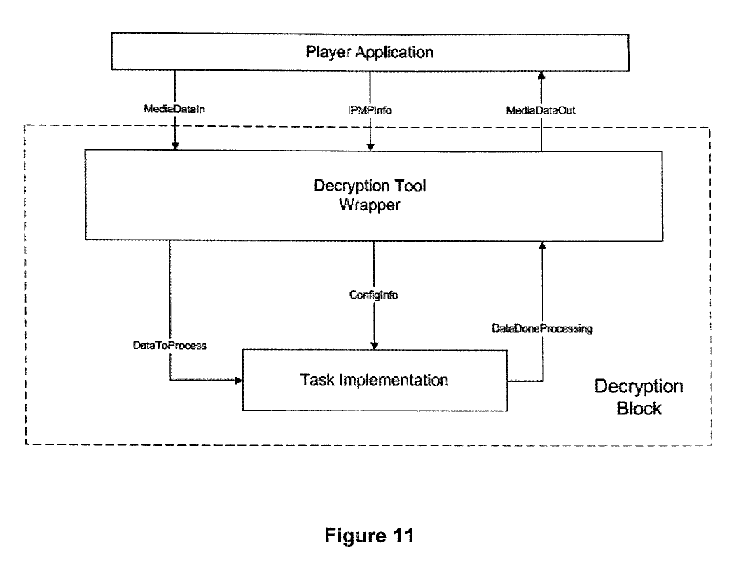

Please refer to FIG. 10, if the IPMP_Task has PreferredToolIDs, the Player checks to see whether one of those Tools is available to it for use. If this step fails, or if there are no PreferredToolIDs, the Player Application begins the process of matching the Class_Code description to one or more Tools that are available to it for use and that is referred to as Class_Code_Reference. Any Tool that implements an IPMP Task has the corresponding Class_Code attached to it. In practice, there are a variety of ways this can be achieved—simply via a registry or by attaching the corresponding instance of Class_Code directly into the Tool itself are two alternatives. The Player application retrieves this Class_Code instance and that is referred to as Class_Code_target.

In order to perform the matching, the Player Application must have a means of comprehending the Class_Code instance. If the schema represented by the Class_Code is unknown to the Player Application, then it acquires the Schema from the specified URL. The parsing process yields values for the leaves defined in the grammar. Both Class_Code_target and Class_Code_ref are parsed. The resulting values are referenced below by the value name in the grammar suffixed with _target and _ref respectively.

The matching process is a series of tests. Tests can be performed in any order, however some orders may be more efficient than others. If any of the tests fail, there is no match, and the Player Application moves on to a new Tool to re-perform the matching.

The first test is that the Class Fields for Class_Code_Target and Class_Code_Ref must be identical. If the Security_Level Element is present in Class_Code_Ref, then the corresponding level_ref must be equal to or less than level_target.

If Performance is present in Class_Code_Ref, then the Performance specified in Class_Code Target, in corresponding terms, must be at least the Performance specified in Class_Code_Ref. If Performance is in terms of MIPS, then value_target should equal or exceed value_ref. If FramePerSecond is specified, then for identical values of width, height and depth, value_target should equal or exceed value_ref. If Latency is specified in Class_Code_ref, then for the same value of unit, value_target should equal or exceed value_ref. If Memory is specified in Class_Code_ref, then the computed memory requirement of ClassCode_ref should be less than or equal to that of Class_Code_target. Memory requirements are computed as value*(baseˆ exponent), as discussed in the grammar disclosure.

Depending on the value of the Class Field, the following further tests are carried out.

For Encryption or Decryption, alg_ref must equal alg_target. Mode_target must at least include Mode_ref. Thus, if Mode_ref is block and Mode_target is either block or both, then the test succeeds. The range of KeyLength_target must at least include the range of KeyLength_ref. This test succeeds if (maxlen_target >=maxlen-ref) AND (minlen_target <=minlen_ref). Depending on the nature of Other information, it must be matched accordingly. If all these tests succeed, then the Target Tool is a valid match for the given IPMP_Task.

For Watermark or Fingerprint, alg_ref must equal alg_target. If Code is specified in Class_Code_ref, then all code_ref values must appear as code_target values. i.e. Code_target must be a superset of Code_ref. Depending on the nature of Other information, it must be matched accordingly. If all these tests succeed, then the Target Tool is a valid match for the given IPMP_Task.

For Verifier, all cert_ref values must appear as cert_target values, i.e. Certificate_target must be superset of Certificate_ref. Similarly, if Protocol is present in Class_Code_ref then Protocol_target must be a superset of Protocol_ref and if Signature is present in Class-Code_ref then Signature_target must be a superset of Signature_ref. Depending on the nature of Other information, it must be matched accordingly. If all these tests succeed, then the Target Tool is a valid match for the given IPMP_Task.

For Parser and Writer, name_target must equal name_ref. The Version specified by Class_Code_target must be greater than or equal to that specified by Class_Code_ref. This is true if major_target is larger than major_ref. It is also true in the case that major_target is equal to major_ref if minor_target is greater than or equal to minor_ref. It is false otherwise. If a suitable parser or writer cannot be found, but SchemaURL is specified in Class_Code_ref, then it may be possible for some types of Player Applications to generate the required Parser/Writer on the fly.

If no Tools available to the Player Application match using the above process and a ToolCode Element is specified in the IPMP_Task instance, then the Player Application may retrieve the Tool contained therein. The value of format indicates the format of the data that follows. Examples are a CAB file format with subsequent data being an ActiveX installation package, or Java with the following Data being machine-independent Java byte code. Note that the data may be directly included if Data is present, or may require separate retrieval from the specified URL.

Once a Tool is matched to a IPMP_Task, then the RefToolId specified in the IPMP_Task is mapped by the Player Application to this Matched Tool, for this specific Portable Protected Media. Any reference to the RefToolId in this Portable Protected Media will be interpreted by the Player Application to be a reference to the corresponding Matched Tool.

If any IPMP_Tool_Aggregation Element(s) are present, these can now be processed. If no Tool can be found to match the required Task, then it follows that the Protected Media cannot be processed at the given Terminal by the given Player Application unless new resources are obtained externally. Thus, processing of the content may be stopped by the Application at this point.

For each IPMP_Tool_Aggregation Element, each required Tool is retrieved for execution—this process is called Instantiation. If the value of the ToolID is one specified as the RefToolId of any IPMP_Task in the preceding IPMP_Task_List, then the corresponding Matched Tool is already known and can be Instantiated. If any IPMP_Task definitions occur in the IPMP_Tool_Aggregation instance, then corresponding Matching Tools are found per the discussion above and Instantiated.

InCode-OutCode matching is then performed. Any unmatched codes that correspond to pre-defined contact points in the Player Application are connected accordingly. The gateway Tool is the recipient of any information in the Portable Protected Media that is addressed to the value of ReftoolId in the instance of IPMP_Tool_Aggregation. For all other purposes, any reference to this RefToolId in this Portable Protected Media will be interpreted by the Player Application to be a reference to the entire Aggregation.

FIGS. 11A to 11C show an example to illustrate the use of the Parametric Description to indicate requirements for a Tool in Portable Protected Media, to indicate the capabilities of a Tool, and to match a Tool to the said requirements respectively.

The Portable Protected Media of FIG. 11 requires DES decryption in stream cipher mode with a key length of 64. Security and Performance criteria are not specified in this example, for simplicity sake. The resultant IPMP_Task carries the salient fields as depicted under “Reference Task” in FIG. 11A. As shown in FIGS. 11B and 11C, the Player Application has access to two Parametric Tools—Tool 1 and Tool 2. Both carry corresponding Parametric Representations of the Tasks they embody. Note that Tool 1 in fact embodies two different Tasks—one of Rights Language Parsing (essentially Parsing) for XrML schema 1.0.34 and the other of 48-64 bit keylength AES decryption in block cipher mode. Hence it has two instances of IPMP_Task associated with it. In this sense, it actually functions as two separate IPMP Tools from a functionality point of view.

The Player Application first picks up Tool 1 as a Target Tool to query for a match with the Reference Task. It parses the first IPMP_Task instance of Tool 1, as well as the Reference Task. The Field Code of the Reference is Decryption, whereas that of the Target Task is Parser. Hence a mismatch is detected. It then parses the second IPMP_Task instance of Tool 1. The Field Codes are identical between the target and the reference (both are Decryptor), but the algorithm IDs are not identical and so a mismatch is detected.

The Player Application then picks up Tool 2 as a Target Tool, and parses its Parametric Description. The field codes are identical, as are the algorithm values. The reference key value, 64, is within the target key range of 48 to 128. The target also supports the stream cipher mode required by the reference. The target Task includes performance information, however this is not pertinent to the current matching process since the reference does not include performance information. Thus, a match is detected. For the purpose of this Portable Protected Media, the Player Application will always interpret the ReftoolId associated with the reference IPMP Task as a reference to Tool 2.

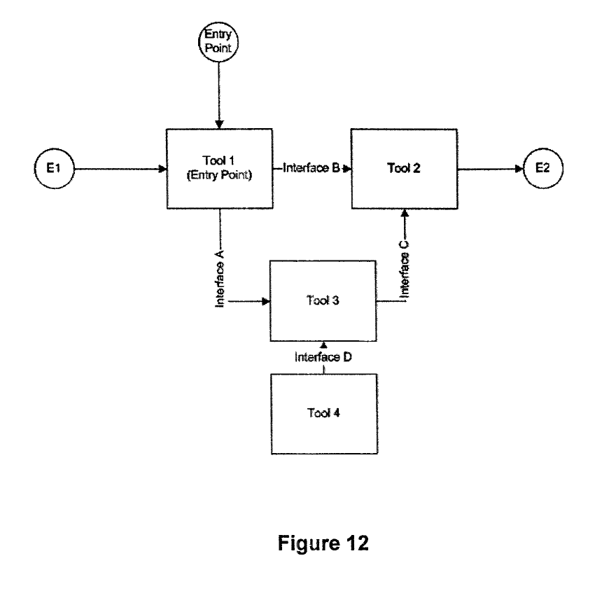

As FIG. 4 indicates the relationship of a Task Wrapper to a Task, FIG. 12 illustrates how this can be embodied into a Parametric Aggregation. As indicated in the discussion of FIG. 4, the Task Wrapper is often a Closed Tool referenced by a unique identifier while the Task itself is often an Open Tool that can be specified via a Parametric Description. Parametric Aggregation can then be used to allow the two Tools to form a single functional unit.

For example, the Task is that of DES decryption in stream cipher mode with a key length of 64. Since the Task Wrapper is equivalently embodied by the following Tools: ToolX, ToolY, ToolZ, the interfaces between the Wrapper and the Task are as shown in the following exemplary parametric representation.

While authoring, the IPMP_Task_List is first created. For example, a typical IPMP_Task_List is listed below:

IPMP_Task_List
(

IPMP_Task //for the decryption task
(
Class_Code

| ( | | |
|---|---|---|
| Decryption | (Algorithm:DES | Mode:stream |

Keylength: 64 64)

Security_Level:high
)
RefToolId:DesDecrypt

(PreferredToolId:ToolD1 ToolD2)

)
IPMP_Task //list of alternative Wrapper embodiments
(

RefToolId:DesWrapper
(PreferredToolId: ToolX ToolY ToolZ)

)

)
Subsequently, the Parametric Aggregation is generated. For

example, it may look like this.

IPMP_Tool_Aggregation
(

Aggregate
(

| ToolID: DesWrapper | | | |
|---|---|---|---|
| (InCode | : | MediaDataIn, | IPMPInfo, |

DataDoneProcessing)

| | | |
|---|---|---|
| (OutCode: | MediaDataOut, | ConfigInfo, |

DataToProcess)

)
Aggregate
(

ToolID: DesDecrypt
(InCode: ConfigInfo, DataToProcess)
(OutCode: DataDoneProcessing)

)
RefToolId: DecryptionBlock

)

Within the Aggregation called DecryptionBlock, the Tool DesWrapper forms the gateway. MediaDataIn, MediaDataOut, and IPMPInfo are unmatched contact points, these are the connections with the Player Application respectively where media data is received, media data is returned, and IPMP information is received by DecryptionBlock per the Portable Protected Media, but by the DesWrapper in effect.

DesWrapper sends correctly formatted media data to DesDecrypt via DataToProcess, and retrieves the processed data via the DataDoneProcessing interface. Configuration information is sent from DesWrapper to DesDecrypt via the ConfigInfo interface—note that this is therefore an OutCode for DesWrapper and an InCode for DesDecrypt.

This concludes the process of authoring. Now during playback, the Player Application parses the IPMP_Task_List and matches the listed tasks to appropriate Tools that are available to it.

For example, when it parses the Parametric Description for DesDecrypt, it does not have ToolD1 or ToolD2, but does have a Tool ToolDx that meets the specifications. Hence it maps ToolDx to the RefId of DesDecrypt. Also, when the Player Application parses the Parametric Description for DesWrapper, it finds that it has ToolY available. Hence it maps ToolY to the RefID of DesWrapper for the duration of this Portable Protected Media.

Now the Player Application processes the Parametric Aggregation. It interprets the ToolID DesDecrypt as a reference to ToolDx and the ToolID DesWrapper as a reference to ToolY. Therefore it instantiates ToolDx and ToolY and sets up the ConfigInfo, DataToProcess and DataDoneProcessing connections between them as specified. It further sets up connections between itself and ToolY for MediaDataIn, MediaDataOut and IPMPInfo. Whenever the Portable Protected Media sends IPMP Information for DecryptionBlock, this is passed to this instance of ToolY via the IPMPInfo interface. All Media Data itself is sent and retrieved in a similar manner via the MediaDataIn and MediaDataOut interfaces.

A different Portable Protected Media may use one of ToolA, ToolB or ToolC as a Wrapper for the DES decryption Tool. In this case, the Parametric Description for DesWrapper will list ToolA-C instead of ToolX-Z and the remaining process will remain the same, mutatis mutandis. Thus, the same Player Application can expect to play media protected by different IPMP Systems. On the other hand, a different Player Application may have ToolD1 and Tool X instead of ToolDx and Tool Y. The same process as that mentioned for the above Player Application occurs, mutatis mutandis. Thus, a protected portable media is now authored with contents that can be processed for playback on a variety of different players.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A publishing-playback system includes an authoring-publishing means for authoring and transmitting a protected media data to a user-application means for media-data playback with said protected media data protected by several intellectual property protection and management (IPMP) systems wherein:
said authoring-publishing means includes a parametric representation means for generating a parametric definition of IPMP tasks for attaching to said protected media data for said user-application means to receive said protected media and to response in real time to said parametric definition in applying one of said several IPMP systems.

2. The publishing-playback system of claim 1 wherein:
said parametric definition of IPMP tasks further comprising a tool list for including a list of tools executable by said user application means.

3. The publishing-playback system of claim 2 wherein:
said user-application means further includes a parametric tool means to perform a description matching for selecting a tool from said tool list in response to an IPMP task included in said parametric definition.

4. The publishing-playback system of claim 1 wherein:
said parametric representation means further includes a grammar means for arranging said parametric definition according to as grammar of a structured language.

5. The publishing-playback system of claim 1 wherein:
said parametric definition of IPMP tasks further comprising a tool-code for enabling said user-application means to acquire a tool from an external resource to process said protected media data.

6. The publishing-playback system of claim 1 wherein:
said parametric definition of IPMP tasks further comprising an indication of representing a complete or a partial part of an IPMP system.

7. The publishing-playback system of claim 1 wherein:
said parametric definition of IPMP tasks further comprising at least a portion provided in a text compression form.

8. The publishing-playback system of claim 1 wherein:
said parametric definition of IPMP tasks further comprising at least a portion provided in a machine language.

9. The publishing-playback system of claim 1 wherein:
said parametric definition of IPMP tasks further comprising at least a portion provided as an executable code by said user-application means.

10. The publishing-playback system of claim 1 wherein:
said parametric definition of IPMP tasks further comprising at least a pre-condition required for said user-application means to authorize said user-application means to process said protected media data.

11. The publishing-playback system of claim 1 wherein:
said parametric definition of IPMP tasks further comprising at least a behavior-limit for said user-application means to use said protected media data under an absence of permission condition of said user-application means.

12. The publishing-playback system of claim 1 wherein:
said parametric definition of IPMP tasks further comprising at least a consumption-limit for defining a limited consumption of said protected media data by said user-application means under an absence of permission condition of said user-application means.

13. The publishing-playback system of claim 1 wherein:
said parametric definition of IPMP tasks further comprising at least a detail task definition for defining an IPMP task.

14. The publishing-playback system of claim 1 wherein:
said parametric definition of IPMP tasks further comprising at least a detail algorithm definition for defining an algorithm required by an IPMP task.

15. The publishing-playback system of claim 1 wherein:
said parametric definition of IPMP tasks further comprising at least a combined task definition for defining a combined IPMP task by combining two IPMP tasks.

16. The publishing-playback system of claim 1 wherein:
said parametric definition of IPMP tasks further comprising a task implementation identifier for including an executable code in said parametric definition.

17. The publishing-playback system of claim 1 wherein:
said parametric definition of IPMP tasks further comprising a task configuration definition for representing a configuration of an IPMP task.

18. The publishing-playback system of claim 1 wherein:
said parametric definition of IPMP tasks further comprising an access data requirement for providing data required by said user-application means in accessing an access unit.

19. The publishing-playback system of claim 1 wherein:
said parametric definition of IPMP tasks further comprising an output data destination for defining a destination of an output generated by an IPMP task in said user-application means.

20. The publishing-playback system of claim 1 wherein:
said parametric definition of IPMP tasks further comprising a missing resource process for defining a process to obtain a missing resource to perform an IPMP task.

21. The publishing-playback system of claim 1 wherein:
said user-application means further comprising a task logging means for generating and logging task execution processes in performing an IPMP task.

22. The publishing-playback system of claim 1 wherein:
said parametric definition of IPMP tasks further comprising a list of input configuration parameters for configuring a set of input data to an IPMP task.

23. The publishing-playback system of claim 1 wherein:
said parametric definition of IPMP tasks further comprising a list of output configuration parameters for configuring a set of output data generated from an IPMP task.

24. The publishing-playback system of claim 1 wherein:
said parametric definition of IPMP tasks further comprising a task sequence for defining a sequential order to carry out a list of IPMP tasks.

25. The publishing-playback system of claim 1 wherein:
said parametric definition of IPMP tasks further comprising an IPMP task appendix for appending and adding new IPMP tasks while keeping an existing IPMP task unchanged.

26. The publishing-playback system of claim 1 wherein:
said parametric definition of IPMP tasks further comprising a error detection data for defining a method for detecting and rectifying an error occurred in transmitting said protected media data to said user-application means.

27. A protected media data authored by an authoring-publishing means for transmitting to a user-media-player for playback, said protected media data comprising:
a parametric definition of intellectual property management and protection (IPMP) tasks for said user-media player to receive said protected media data and to response in real time to said parametric definition in applying one of several IPMP systems for processing and playback of said protected media.

28. The protected media data of claim 27 wherein:
said parametric definition of IPMP tasks further comprising a tool list for including a list of tools executable by said user-media-player.

29. The protected media data of claim 28 wherein:
said IPMP tasks further includes a tool list provided for said user-media-player to perform a description matching for selecting a tool from said tool list to deploy on said user-media-player in response to an IFMP task included in said parametric definition.

30. The protected media of claim 27 wherein:
said parametric definition are arranged according to a grammar of a structured language.

31. The protected media data of claim 27 wherein:
said parametric definition of IPMP tasks further comprising a tool-code for enabling said user-media-player to acquire a tool from an external resource to process said protected media data.

32. The protected media data of claim 27 wherein:
said parametric definition of IPMP tasks further comprising an indication of representing a complete or a partial part of an IPMP system.

33. The protected media data of claim 27 wherein:
said parametric definition of IPMP tasks further comprising at least a portion provided in a text compression form.

34. The protected media data of claim 27 wherein:
said parametric definition of IPMP tasks further comprising at least a portion provided in a machine language.

35. The protected media data of claim 27 wherein:
said parametric definition of IPMP tasks further comprising at least a portion provided as an executable code by said user-media-player.

36. The protected media data of claim 27 wherein:
said parametric definition of IPMP tasks further comprising at least a pre-condition required for said user-media-player to authorize said user-media-player to process said protected media data.

37. The protected media data of claim 27 wherein:
said parametric definition of IPMP tasks further comprising at least a behavior-limit for said user-media-player to use said protected media data under an absence of permission condition of said user-media-player.

38. The protected media data of claim 27 wherein:
said parametric definition of IPMP tasks further comprising at least a consumption-limit for defining a limited consumption of said protected media data by said user-media-player under an absence of permission condition of said user-media-player.

39. A parametric representation method comprising:
a) representing an intellectual property protection and management (IPMP) system as a combination of IPMP components each includes at least a task for protecting a protected media;
b) authoring said combination of components together with a structure of at least one IPMP system into said protected media; and
c) interpreting and reconstructing said protected media with said combination of IPMP components and said structure of IPMP system for play-back said protected media.
